(19) United States
(12) Patent Application Publication
(10) Pub. No.: US 2009/0327122 A1
(43) Pub. Date: Dec. 31, 2009

(54) METHOD AND SYSTEM FOR FACILITATING CHARITABLE DONATIONS

(76) Inventor: Assaf Isac, Tel-Aviv (IL)

Correspondence Address: Professional Patent Solutions, P.O. BOX 654, HERZELIYA PITUACH, 46105, IL

(21) Appl. No.: 12/410,591

(22) Filed: Mar. 25, 2009

Related U.S. Application Data
(60) Provisional application No. 61/039,114, filed on Mar. 25, 2008.

(51) Int. Cl. G06Q 20/00; A63F 9/24; G06Q 50/00

(52) U.S. Cl. 705/39; 463/25

(57) ABSTRACT

Disclosed is a system and method for facilitating charitable donations. A first possible outcome of a game is associated with a first charity, online wagers against the first possible outcome are accepted and in response to the first possible outcome actually occurring, all, or a portion, of the wagered sums are electronically credited to an account associated with the first charity.

### FIELD OF THE INVENTION

The present invention generally relates to the field of Fundraising. More specifically, the present invention relates to a method and system for facilitating charitable donations.

### BACKGROUND

The idea of charitable giving is as old as history itself. Originally almsgiving entailed the benefactor giving the goods directly to the receiver. People who could not support themselves or who feigned such inability would become beggars.

In time institutions evolved to carry out the labor of assisting the poor and otherwise needy. These institutions are called charities. These included orphanages, food banks, religious orders dedicated to care of the poor, hospitals, organizations that visit the homebound and imprisoned, and many others. Such institutions allow those whose talents or schedules do not lend themselves to caring for the needy yet still wish to “give” to enable others to do so, both by providing money and other goods for the work and supporting them while they do the work. Institutions can also attempt to more effectively sort out the actually needy from those who fraudulently claim charity and to more precisely direct the efforts to specific causes. Thus, a person who wishes to promote a specific charitable cause can do so by donating to a charity that is specifically associated with that cause. For example, one who is concerned about the affects of the practice of whaling on the species, and yet does not have the time or inclination to go out with a boat in arctic waters to chase whalers, can still make a difference by donating to an organization such as Greenpeace.

Over time, these institutions have diversified in their altruistic purposes to include all matters of public concern and not merely to helping needy people. Nowadays, one can find charities active in almost every field of public work, from wildlife preservation to promoting responsible parenting.

The institutionalization of charitable giving has also allowed individuals with similar concerns to join together in a common effort, greatly increasing the effectiveness and influence of their donations. This merger of donors with common interests also allows for action which would not be possible on an individual scale. One does not need much imagination to realize that one man demonstrating in front of congress would not achieve the desired effect. Equally ineffective would be one man carrying a sandwich to a starving nation in Africa, and so on. Or, in other words, the ability to organize and coordinate a large group of people allows these organizations to go beyond helping a needy individual or individuals and into making changes in the causes of the problem at hand.

Yet even after all this sophistication in the implementation of charitable giving at the core is still an individual who wishes to distribute a portion of his wealth to an altruistic purpose. Thus, virtually all charities require for their operation a method for collecting these funds, also known as fundraising.

Fundraising for charitable organizations has traditionally required a combination of personal requests, direct-mail asks, telephone solicitations and special events. The development of the internet has changed this reality.

The practice of fundraising online has evolved. From the basic strategy of the Donate Now button, where organizations developed a simple web form to capture credit card gifts and posted a “donate now” button on their website, more complex strategies using lessons from traditional direct mail appeals and the expediency of email campaigns to solicit gifts from a list of opt-in supports have developed. Organizations have begun employing new strategies with web based tools like blogs, community networking, social peer-groups and advanced virtual worlds.

One relevant example of an established fundraising technique is the staging of different forms of gambling events in which the proceeds or a portion of the proceeds are donated to charity. This form of fundraising has been very successful over the years and continues to provide large revenues for many charitable causes. This is due in no small part to the fact that gaming activities are illegal in most jurisdictions when the benefactor is not a charity. Therefore, in many areas such charity sponsored gambling is the only gambling available and lures many participants who are not as interested in the charity as they are in the gambling. The most popular form of charitable gaming is probably “Bingo Night,” which is practiced in many churches in America. Similarly, many charities sponsor casino events, in which, again, the proceeds or a portion thereof go to the sponsoring charity.

Gambling as a fundraising technique for charitable causes is already being implemented online. It is, however, still limited to gambling style games, such as blackjack and roulette, and fails to take into account the immense popularity of online competitive gaming. (e.g. games such as Chess and Backgammon, which are played endlessly online by millions). Furthermore, the online version of this technique lacks the advantages mentioned above for non-online gambling as a fundraising technique. More specifically, it is not the only gambling venue available online.

Competitive games, such as the ones mentioned above, are far more entertaining for the users, both due to their competitive and interactive nature and their involvement of an element of skill which is largely absent in the gambling style games.

While gambling style games lend themselves naturally to fundraising, as they were developed for the purpose of monetary gain, holding an inherent “house” advantage and being played between the participant and the “house”. Competitive games are not so constructed, being intended for leisure, as social activities. Therein lies their appeal. These games do not involve a “house” and are played between the participants. Thus, they do not inherently generate considerable revenues usable for fundraising.

Whereas in gambling style games the purpose is to win money from the “house” and thus the result of losing is to give the “house” money to pass along to a charity, in competitive games, the purpose is to beat an opponent or opponents and the result of a loss is at best to give money to the winner—leaving little profit for the organizer of the game.

### SUMMARY OF THE INVENTION

The present invention is a method and system for facilitating charitable donations. According to some embodiments of the present invention there is provided a transaction server or servers which may maintain on an associated database, account information for each of a set of charities. The transaction server may also maintain on the same or different database account information for each of a set of potential charitable donors, in which charitable donors may deposit funds in their respective accounts using one or more of any known funding methods, including online funding methods. The transaction server may or may not allow potential donors to withdraw funds from their accounts or to transfer them to other accounts, of either other sets of donors or sets of charities. The transaction server may also allow donors to designate a set or sets of charities to receive the balance of their account in the event of their account being inactive for a specified period of time. The transaction server may also be adapted to transfer funds from the sets of charities accounts maintained on the database directly to the charities or to their financial institution, periodically or when triggered to do so, by the administrator or by the charities themselves.

According to some further embodiments of the present invention, there may also be provided a gaming server or servers which may be functionally associated with the transaction server over a data network. The gaming server, in conjunction with the transaction server and through one or more data communication modules, may be adapted to facilitate one or more online games for potential donors, including games of skill, games of chance and games combining the two. The code for each of the one or more games may be stored on one or more storage devices functionally associated with the gaming server. As part of at least some of the one or more games, each of two or more donors may be invited to place a wager or wagers against each other on the outcome (e.g. who wins) of a given game or game round or tournament, and to designate one or more of the set of charities as a beneficiary of the winnings of the given wager. According to some embodiments of the present invention, each of the potential donors may designate a different charity to receive the proceeds of the wager if that potential donor wins a game or a game round. According to further embodiments of the present invention, the charity designated by the winner of the wager will receive the total amount waged by all potential donors. According to yet a further embodiment of the present invention, the charity designated by the winning potential donor will only receive the amount waged by losing potential donors and the winning potential donor will be credited the funds he wagered. According to yet a further embodiment of the present invention, the designated charities may each receive a portion of the amount waged in accordance with a ratio determined by the outcome/score of the game, game round or tournament. According to yet a further embodiment of the present invention, the charity designated by the winning potential donor will only receive a portion of the amount waged by losing potential donors and the winning potential donor will be credited the funds he wagered and the remaining portion of the amount waged by losing potential donors.

According to yet a further embodiment of the present invention, the servers may be adapted to receive information, possibly by means of a structured form, from the donors and/or charities through one or more data communication modules. This may facilitate the construction and maintenance of the associated databases.

The transaction server may be adapted to credit and/or debit accounts associated with a given game in accordance with the results of the associated wagers. According to yet another embodiment of the present invention, the transaction server may allocate a portion of the wagers to pay for operational, maintenance and administrative costs and may transfer these funds to an account designated for this purpose.

According to some other embodiments of the current invention, the gaming server may also maintain on the same or a different database profile information for each of the sets of potential charitable donors, which may list one or a set of charities to receive the proceeds of the donor's game winnings, the donors preferred games, the donors game history and skill level, and/or other relevant data regarding the specific donor. According to further embodiments of the present invention, a profiling application may:
1) Suggest one or a set of potential charities to a potential donor based on personal information provided by the donor.
2) Match donors with other donors according to profile characteristics, such as: game preferences, skill level, preferred charities, etc.
3) Allow for handicapping in the event that donors of different skill levels wish to compete.
4) Provide charities with statistical data regarding their donors.
5) Provide the operator of the system with data on user preferences and habits, which may facilitate improvements of the system.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a functional block diagram illustrating the functional blocks of an exemplary system for facilitating charitable donations in accordance with some embodiments of the present invention;

FIG. 2 if a first portion of a flowchart including steps of exemplary online method for facilitating charitable donations in accordance with some embodiments of the present invention;

FIGS. 3&4 are each possible alternate exemplary completions of the flowchart in FIG. 2, each of which, in conjunction with FIG. 2, illustrate possible steps of an exemplary online method for facilitating charitable donations in accordance with some embodiments of the present invention. More specifically, FIG. 3 illustrates an exemplary online method for facilitating charitable donations in which, the winner of a competitive game held online determines a charity to which the loser's wager in the game is donated, and FIG. 4 illustrates an exemplary online method for facilitating charitable donations in which the winner of a competitive game held online determines a charity to which both the winners and the loser's wager in the game is donated;

FIGS. 5-22 are each a screenshot of a screen of an exemplary online system for facilitating charitable donations in accordance with some embodiments of the present invention and further described below;

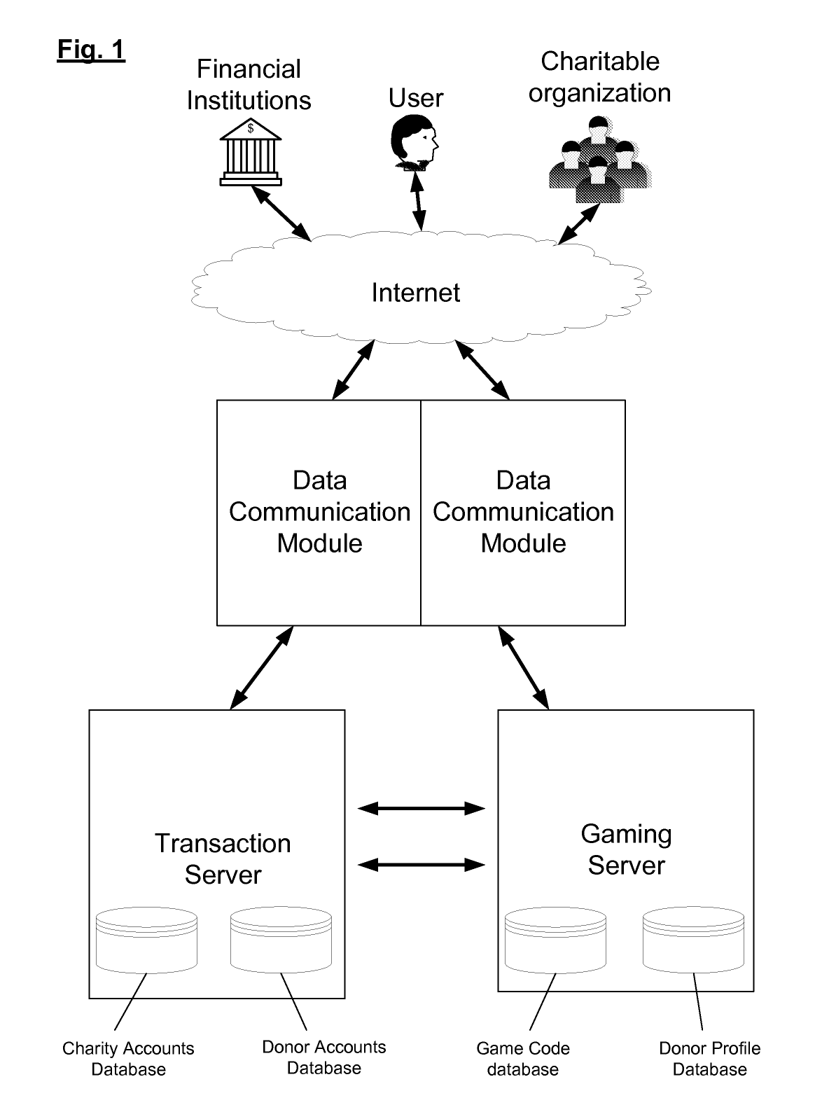

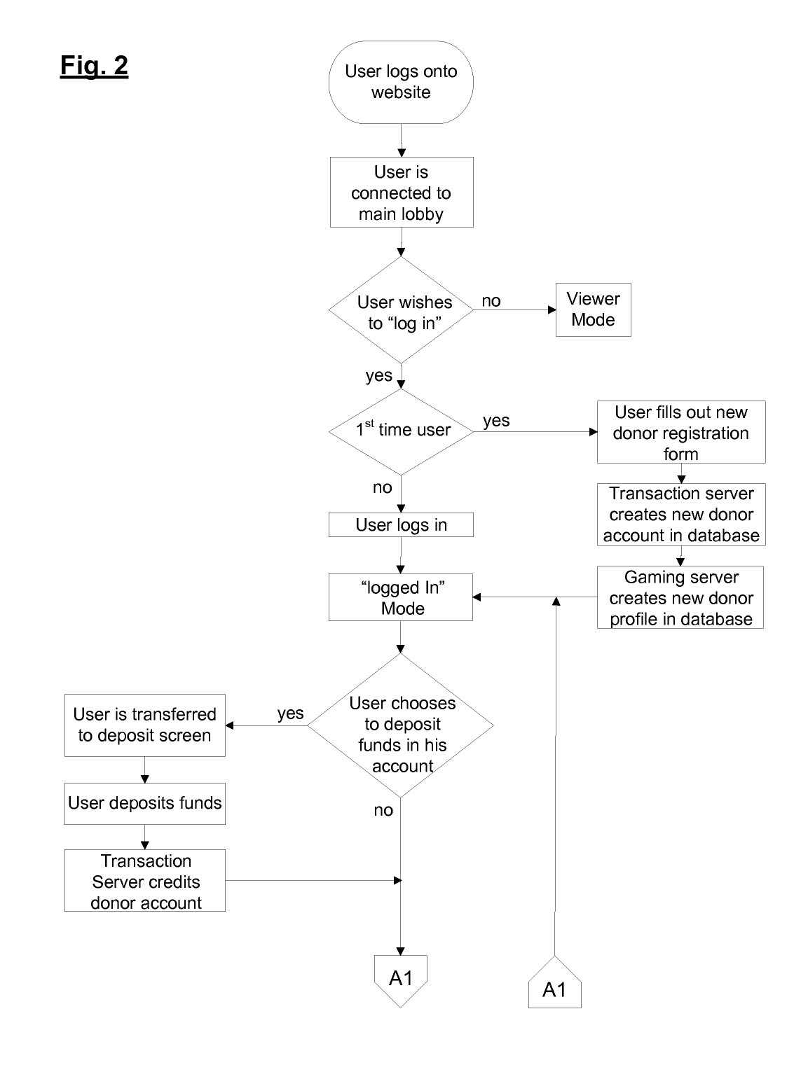

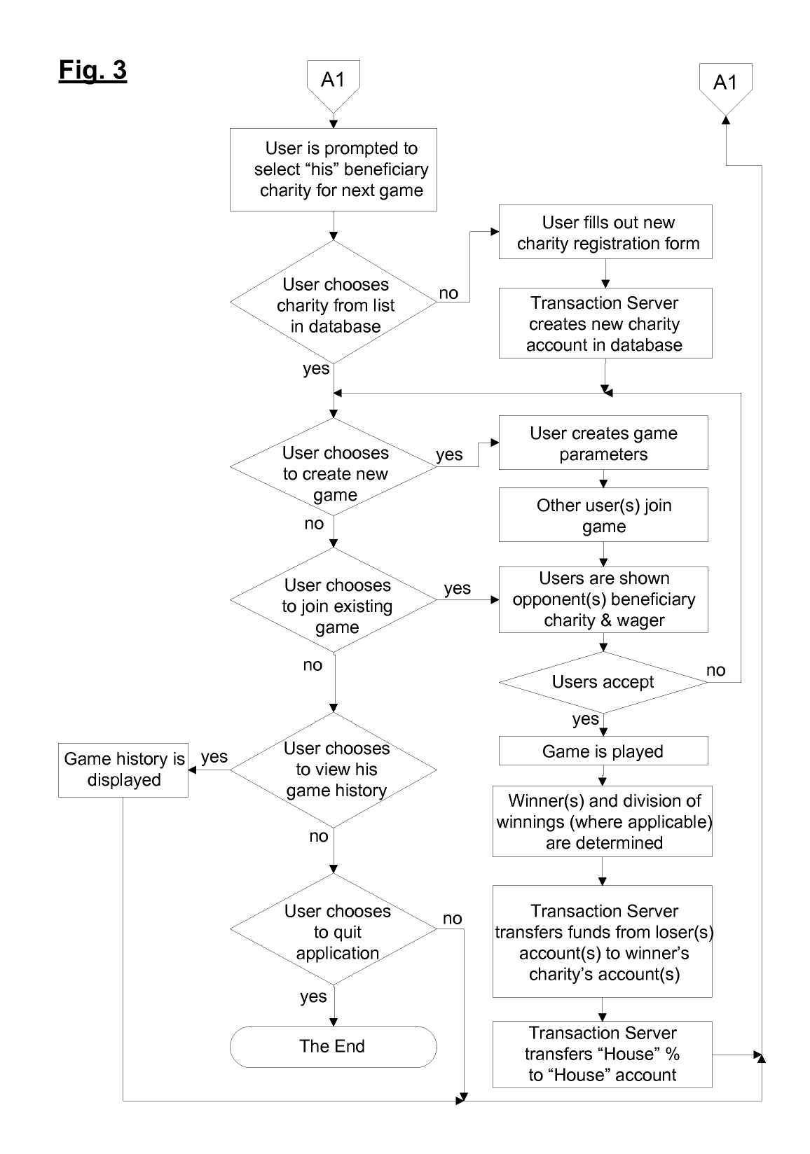

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. The term server may refer to a single server or to a functionally associated cluster of servers.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Terms in this application relating to distributed data networking, such as send or receive, may be interpreted in reference to Internet protocol suite, which is a set of communications protocols that implement the protocol stack on which the Internet and most commercial networks run. It has also been referred to as the TCP/IP protocol suite, which is named after two of the most important protocols in it: the Transmission Control Protocol (TCP) and the Internet Protocol (IP), which were also the first two networking protocols defined. Today's IP networking represents a synthesis of two developments that began in the 1970s, namely LANs (Local Area Networks) and the Internet, both of which have revolutionized computing.

The Internet Protocol suite—like many protocol suites—can be viewed as a set of layers. Each layer solves a set of problems involving the transmission of data, and provides a well-defined service to the upper layer protocols based on using services from some lower layers. Upper layers are logically closer to the user and deal with more abstract data, relying on lower layer protocols to translate data into forms that can eventually be physically transmitted. The TCP/IP reference model consists of four layers.

Layers in the Internet Protocol Suite

The IP suite uses encapsulation to provide abstraction of protocols and services. Generally a protocol at a higher level uses a protocol at a lower level to help accomplish its aims. The Internet protocol stack has never been altered, by the IETF, from the four layers defined in RFC 1122. The IETF makes no effort to follow the seven-layer OSI model and does not refer to it in standards-track protocol specifications and other architectural documents.

| | |
|---|---|
| 4. Application | DNS, TFTP, TLS/SSL, FTP, Gopher, HTTP, IMAP, |
| | IRC, NNTP, POP3, SIP, SMTP, SNMP, SSH, |
| | TELNET, ECHO, RTP, PNRP, rlogin, ENRP |
| | Routing protocols like BGP, which for a |
| | variety of reasons run over TCP, may also |
| | be considered part of the application or |
| | network layer. |
| 3. Transport | TCP, UDP, DCCP, SCTP, IL, RUDP |
| 2. Internet | Routing protocols like OSPF, which run over |
| | IP, are also to be considered part of the |
| | network layer, as they provide path selection. |
| | ICMP and IGMP run over IP and are considered |
| | part of the network layer, as they provide |
| | control information. |
| | IP (IPv4, IPv6) |
| | ARP and RARP operate underneath IP but above |
| | the link layer so they belong somewhere in |
| | between. |
| 1. Network access | Ethernet, Wi-Fi, token ring, PPP, SLIP, FDDI, |
| | ATM, Frame Relay, SMDS |

It should be understood that any topology, technology and/or standard for computer networking (e.g. mesh networks, infiniband connections, RDMA, etc.), known today or to be devised in the future, may be applicable to the present invention.

The present invention is a method and system for facilitating charitable donations. According to some embodiments of the present invention there is provided a transaction server or servers which may maintain on an associated database, account information for each of a set of charities. The transaction server may also maintain on the same or different database account information for each of a set of potential charitable donors, in which charitable donors may deposit funds in their respective accounts using one or more of any known funding methods, including online funding methods. The transaction server may or may not allow potential donors to withdraw funds from their accounts or to transfer them to other accounts, of either other sets of donors or sets of charities. The transaction server may also allow donors to designate a set or sets of charities to receive the balance of their account in the event of their account being inactive for a specified period of time. The transaction server may also be adapted to transfer funds from the sets of charities accounts maintained on the database directly to the charities or to their financial institution, periodically or when triggered to do so, by the administrator or by the charities themselves.

According to some further embodiments of the present invention, there may also be provided a gaming server or servers which may be functionally associated with the transaction server over a data network. The gaming server, in conjunction with the transaction server and through one or more data communication modules, may be adapted to facilitate one or more online games for potential donors, including games of skill, games of chance and games combining the two. The code for each of the one or more games may be stored on one or more storage devices functionally associated with the gaming server. As part of at least some of the one or more games, each of two or more donors may be invited to place a wager or wagers against each other on the outcome (e.g. who wins) of a given game or game round or tournament, and to designate one or more of the set of charities as a beneficiary of the winnings of the given wager. According to some embodiments of the present invention, each of the potential donors may designate a different charity to receive the proceeds of the wager if that potential donor wins a game or a game round. According to further embodiments of the present invention, the charity designated by the winner of the wager will receive the total amount waged by all potential donors. According to yet a further embodiment of the present invention, the charity designated by the winning potential donor will only receive the amount waged by losing potential donors and the winning potential donor will be credited the funds he wagered. According to yet a further embodiment of the present invention, the designated charities may each receive a portion of the amount waged in accordance with a ratio determined by the outcome/score of the game, game round or tournament. According to yet a further embodiment of the present invention, the charity designated by the winning potential donor will only receive a portion of the amount waged by losing potential donors and the winning potential donor will be credited the funds he wagered and the remaining portion of the amount waged by losing potential donors.

According to yet a further embodiment of the present invention, the servers may be adapted to receive information, possibly by means of a structured form, from the donors and/or charities through one or more data communication modules. This may facilitate the construction and maintenance of the associated databases.

The transaction server may be adapted to credit and/or debit accounts associated with a given game in accordance with the results of the associated wagers. According to yet another embodiment of the present invention, the transaction server may allocate a portion of the wagers to pay for operational, maintenance and administrative costs and may transfer these funds to an account designated for this purpose.

According to some other embodiments of the current invention, the gaming server may also maintain on the same or a different database profile information for each of the sets of potential charitable donors, which may list one or a set of charities to receive the proceeds of the donor's game winnings, the donors preferred games, the donors game history and skill level, and/or other relevant data regarding the specific donor. According to further embodiments of the present invention, a profiling application may:
1) Suggest one or a set of potential charities to a potential donor based on personal information provided by the donor.
2) Match donors with other donors according to profile characteristics, such as: game preferences, skill level, preferred charities, etc.
3) Allow for handicapping in the event that donors of different skill levels wish to compete.
4) Provide charities with statistical data regarding their donors.
5) Provide the operator of the system with data on user preferences and habits, which may facilitate improvements of the system.

Following, there are provided, additional, non-limiting, exemplary embodiment(s) and possible exemplary feature(s) of the present invention. It should be understood that all of the description(s) presented hereinafter are intended solely to illustrate some of the possible implementation(s) of the present invention. It should be clear, to one of ordinary skill in the art, that there are virtually endless variations to the following exemplary embodiment(s).

According to an aspect of the invention, a system for interactive fundraising is disclosed, the system includes a communication interface, for the connecting of multiple users to a server, and the server which is adapted to:
a. authorize multiple users to the system;
b. update a user account balance that is associated with a user of the system in response to a deposition of the user (e.g. a promissory charging liability, such as one received from the user or from a credit card company of the user).
c. determine at least one winner of a skill-based game of at least two players who are users of the system, which is facilitated on a skilled-based game platform provided by the server; and
d. authorize a donation to a donation account that is registered in the server, wherein the authorizing includes: (a) charging a user account of at least one player other than the at least one winner (usually by a game-worth value predetermined by the players of the skill-based game), and (b) crediting a donation account balance (that is associated with a donations raising organization previously registered in the system which was selected by the winner of the game, usually prior to a starting of the skill-based game).

It is noted that, according to an embodiment of the invention, the invention may be implemented using multiple servers, wherein each server of the multiple servers is conveniently adapted to communicate with other one or more servers of the multiple servers to transfer information (e.g. relating to users, winning records, donations, and so forth).

It is noted that the determining includes, according to an embodiment of the invention, determining multiple winners of the skill-based game of more than two players. It is further noted that the determining may also include determining winning ratios of multiple players, wherein the stage of charging of the user account of at least one player is responsive to the winning rations.

For example, the skill-based game may be a Pelmanism game (also known as concentration game or memory game), in which each player receives scoring in response to the number of pairs collected by said player, wherein during the end of the game, the winning ratios are calculated according to said scoring, and the charging of the user account of at least one player is responsive to the winning ratios and thus to the scoring gained by each of the multiple players during the game. It is of course clear to a person who is skilled in the art that similar method could be applied to other multiple players skill-based games other than Pelmanism.

It is further noted that when the term “winner” is used below, it may refer to “at least one winner”, and that the determining of winning ratios and authorizing donations accordingly may be implemented in any of the mentioned below embodiments of the invention.

Conveniently, each of the players selects, prior to a beginning of the skilled based game, a donation raising organization to which a sum (that is responsive to the game-worth value) would be credited if the selecting player would win the skills-based game.

Conveniently, the donation raising organization selected by different users is presented to multiple users of the system, so as to enable users to match up according to the donation raising organizations selected by other users.

It is noted that this can serve for different kinds of users aims; on the one sides, users can wish to play against opponents with whom they share a selection of donation raising organizations (e.g. different organization for wild life preservation, or even the same organization), just enjoying the skills-based game.

On the other hand, users can opt to play against users with whom they disagree with the selection (as is exemplified below).

According to an aspect of the invention, a method for interactive fundraising is disclosed, the method includes:
a. authorizing multiple users to an interactive fundraising system;
b. updating a user account balance that is associated with a user of the system in response to a deposition of the user (e.g. a promissory charging liability, such as one received from the user or from a credit card company of the user).
c. determining at least one winner of a skill-based game of at least two players who are users of the system, which is facilitated on a skilled-based game platform provided by at least one server; and
d. authorizing a donation to a donation account that is registered in the at least one server, wherein the authorizing includes: (a) charging a user account of at least one player other than the winner (usually by a game-worth value predetermined by the players of the skill-based game), and (b) crediting a donation account balance (that is associated with a donations raising organization previously registered in the system which was selected by the winner of the game, usually prior to a starting of the skilled based game).

According to an aspect of the invention, a computer readable medium having computer-readable code embodied therein for interactive fundraising is disclosed, the computer-readable code includes instructions for:
a. authorizing multiple users to an interactive fundraising system;
b. updating a user account balance that is associated with a user of the system in response to a deposition of the user (e.g. a promissory charging liability, such as one received from the user or from a credit card company of the user).
c. determining at least one winner of a skill-based game of at least two players who are users of the system, which is facilitated on a skilled-based game platform provided by at least one server; and
d. authorizing a donation to a donation account that is registered in the server, wherein the authorizing includes: (a) charging a user account of at least one player other than the winner (usually by a game-worth value predetermined by the players of the skill-based game), and (b) crediting a donation account balance (that is associated with a donations raising organization previously registered in the system which was selected by the winner of the game, usually prior to a starting of the skilled based game).

In the following description, a detailed reviewing of different embodiments of the invention is offered. It is clear to a person who is skilled in the art that the following description could be implemented for a system, a method, and a computer program product, mutatis mutandis.

Additionally, it is clear to a person who is skilled in the art that not all the features described below should be implemented in every embodiment of the invention, and that different embodiments of the invention may implement some, all, or none of the following features, on top of the features disclosed above.

Further more, it is noted that many of the following described features include examples (e.g. for screens of the user interface), and that other implementations could be applied.

Conveniently, the method, system (or similar apparatus), or computer program product facilitate global fundraising which is based on the skills of two or more participants playing a skill based game or games. It is noted that such a system (or similar apparatus), or computer program product that facilitates global fundraising as herein disclosed is also referred to as FunDonation, and wherein FunDonation is referred to, it should be kept in mind that such a system or computer program product may also carry other commercial names.

The system (wherein it is again reminded that wherever a system is mentioned below, equivalent implementations could be made for a method, an apparatus, and a computer program product even if not explicitly mentioned) is all about migrating donations and fun, allowing for the 1st time to play skill based games and to donate the profits (wherein a fee can be reduced from the profits, e.g. to cover maintenance and operation costs).

A $100 initial deposit can become a $1000 donation by using one's skills only.

Pertaining to all the different embodiments of the invention, it is noted that users may deposit money to the interactive fundraising system, but conveniently they can never withdraw it, but only to risk it in skill-based game, or to donate it directly (e.g. if they no longer wish to play). According, a money deposited by a no longer active player may be donated to a donation account, usually previously selected by the no longer active player.

Furthermore, the system allows the user to announce which organization worldwide will get the winnings of the game before it starts, motivating people from all around the globe to play each other and for the 1st time transferring amounts of money all over the globe for donation purposes only.

The system is based on a gaming platform that includes one or more skill-based games (e.g. chess, checkers, backgammon, etc.) that allow participants (two or more) from all over the world to compete against each other by playing a skill game over the Internet or any other network.

The competition may be head to head (one on one) or via a tournament system that is a part of the gaming platform.

The players can play a single game or a series of games that will determine the winner.

The players never compete against the ‘house’ but only between themselves.

The nature of the skill based games is that they are based on the skill of the participants. Such games are, by way of example, Chess, Checkers, Backgammon, 8 ball pool, Snooker, Tic Tac Toe, Ping-Pong, Battleship, Trivia and many more.

Conveniently, none of the games is related to gambling, future events prediction or games that are based on elements of luck or chance. Such games may be casino games (Roulette, Black Jack, Slot machines, Caribbean Poker, Video Slots, Video Poker, Pai Gow Poker, Craps, Keno, Baccarat, etc. . . . ), Scratch cards, prediction market or any other game that is NOT based on the skills of the participants.

Before starting the game, each player risks a known mount of money (The players may risk the same amount or different amounts. By way of example, different amounts may be used when a skilled player wishes to play with a less skilled player and gives the less skilled player an opportunity to risk less money).

The winner of the game (or winner/s if in a tournament) conveniently donates only the amount of money won excluding his/her risked amount which is returned to a bankroll of the winner.

Before starting the game, each player declares which organization or cause that is registered in the system he/she will donate the winning's amount (Amount won excluding his risked amount) to.

The donation will be reduced by a fee (e.g. % X of the winning amount) for operating expenses and other expenses of the system as needed.

These innovating features add a new dimension of competition.

For example, a Palestinian will declare that the winning's amount will be donated to an Islamic organization in the occupied territories and an Israeli will declare that the winning's amount will be donated to the Israeli Defense Force.

If the Israeli wins the game, he/she donates the Palestinian's money to the IDF and the original risked money risked by the Israeli is returned to the Israeli's bankroll.

If the Palestinian wins the game, he/she donates the Israeli's money to the Islamic organization and the original risked money risked by the Palestinian is returned to the Palestinian's bankroll.

The system is based on a client/server model.

The servers are connected to each other and some of them are connected to the client. A socket technology is used with a proprietary protocol but the connection can be implemented in other ways as well.

The servers also connect to a Database which is Microsoft SQL Server but may be any other Database. The servers are written in c++ but may be written in any other languages such as Java, C, C# but not limited to those languages.

The client is written in Flash but is not limited to that technology and may be implemented in Sun Java, Adobe Flex, Adobe AIR, Microsoft Silver Light, etc. . . .

### General “Connecting, Please Wait” Component

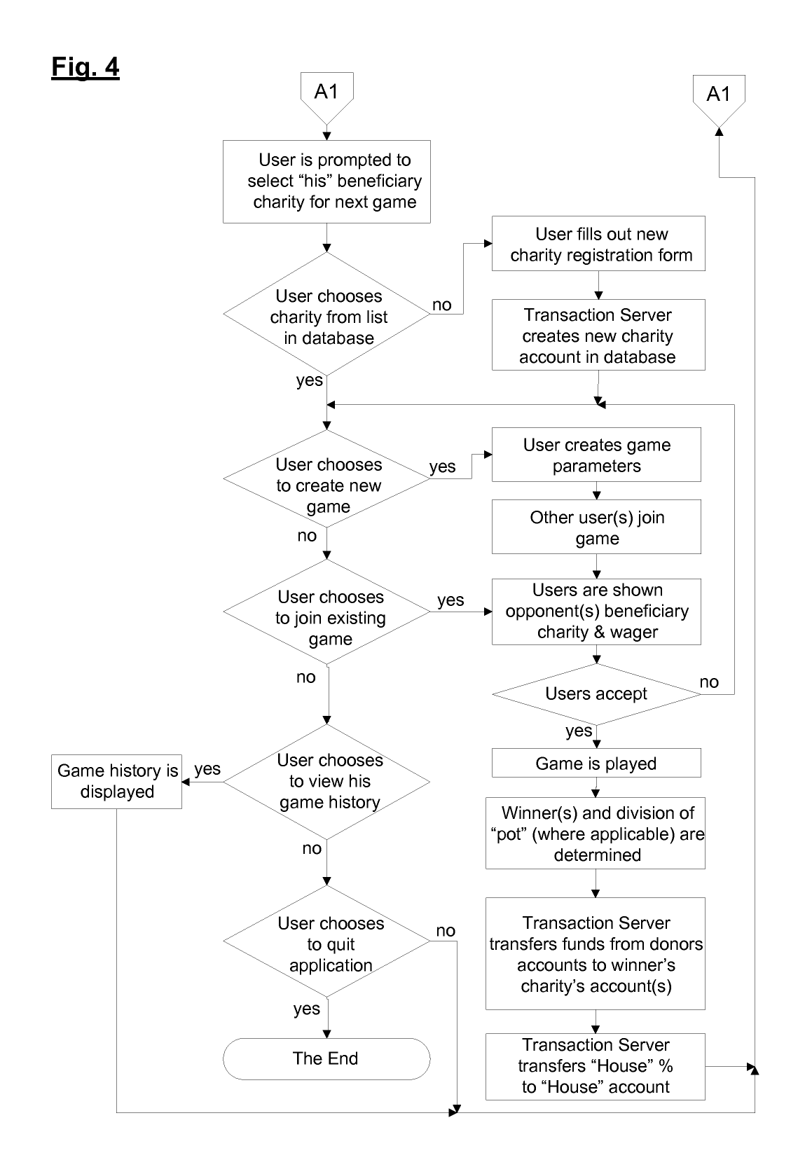

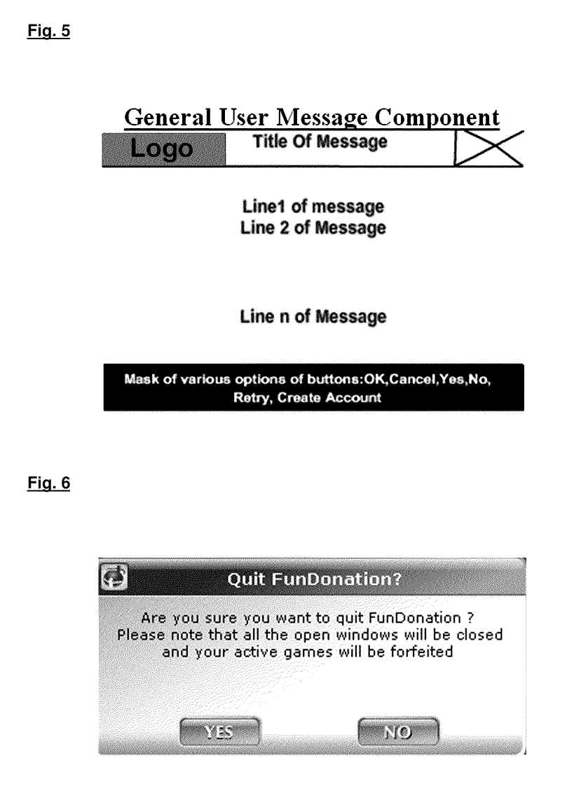

The system may need a general user message as illustrated in FIG. 4 and exemplified in FIG. 5.

Some actions in the system take time to finish. The user should be notified that the system is not idle but waiting for a response from the server.

A general movie clip should be created and be used when needed.

The movie clip should be animated in order to show that the process is taking time and the system is not stuck.

This will also be used before each screen is loaded as a pre loader
a. “FunDonation.org” logo;
b. “Connecting, please wait . . . ” where the dots are animated; or
c. “Loading, please wait . . . ” where the dots are animated

### Main Lobby Screen (Shown in FIG. 6)

The main lobby is the 1st screen the user gets when the application is loaded.

The main lobby's purpose is to help the user navigate between the various games, register to the system and log in to it, display the user the deposit and donate options, displaying the user the status of the application and the user, etc. . . .

The screen should be divided into 2 parts;
a. Offline section: the functional part of the lobby, contains everything but the online section
b. Online section: A narrow strip to the right of the application which will display a web page that contains promotional information.

### Offline Section:

The offline section includes:

Different buttons, one for each game (The buttons themselves should not be animated). For example:
a. “Chess” button. Modes: enabled, disabled, mouse over, pressed
b. “Checkers” button. Modes: disabled
c. “Backgammon” button. Modes: disabled
d. “8 ball Pool” button. Modes: disabled
e. “Snooker” button. Modes: disabled
f. “Tic-Tac-Toe” button. Modes: disabled
g. “Ping Pong” button. Modes: disabled
h. “Battleship” button. Modes: disabled

Connection state MovieClip. The MovieClip displays the current connection state of the application. There are 3 kinds of states:
a. connected
b. disconnected
c. connecting

The MovieClip should have 4 frames:
a. blank
b. connecting
c. connected—should be animated
d. disconnected

Logo of the organization called: “FunDonation.org”

“Deposit” button. Modes: enabled, mouse over

The deposit button will have a title named “Deposit” (The deposit button should also include the String “Account Balance”) and will contains 2 dynamic lines within it:
a. “Money Available: $”[a dynamic text field for the amount]
b. “Money in Play: $”[a dynamic text field for the amount]

“Donate” button. Modes: enabled, mouse over Sound on/off button. Modes: enabled, over. This button has 2 states (wherein There should be an icon for each state):
a. Sound on
b. Sound off

“Help” button. Modes: enabled, over

“Logout” button. Modes: enabled, over

“My History” button. Modes: enabled, mouse over, pressed

Registration/Login Movie Clip is used only if the user has not been logged in. This mode is called “Not logged In yet” mode.

This movieclip contains the following:
a. “Welcome guest”
b. “Account Name:”+[an input text field for the user name]
c. “Password:”+[an input text field(password type) for the user's Password]
d. “Remember me” checkbox
e. “Login” button. Modes: enabled, over, clicked
f. “New user click here” animated button. Modes: enabled, mouse over, clicked

“My next games' revenues will be donated to:”+[combo box with the default value “Not decided yet”]

Under that line should be written in blue like a link the following: “How do I choose which institute or organization to donate to?” {If the user is not logged in, the combo box will have no options for him to choose from. If the user is logged in, he will be shown the 5 recent choices he had in the past if any exists.}

### Online Section:

The online section will be divided into 5 parts:

Top donator of the week:
a. “Top Donator of the week” title
b. Image of the donator (Bill Gates' Image will be used)
c. “User: Bill”
d. “Age: 51”
e. “Game: Chess”
f. “Gender: male”
g. “Country:”+USA Flag icon+“USA”
h. “View profile” button, Modes: enabled, mouse over, clicked

FunDonation.org Time:
a. “FunDonation.org Time” title
b. current time title (In the example, we use 21:45)

Invite your friends button. Modes: Enabled
a. “Invite your friends” title
b. “Share the vision of a better globe
c. “Click here”

FunDonation.org Featured Games:
a. “FunDonation.org Featured Games” title
b. Animation of a chess board
c. Explanation of the Chess game: “Chess is probably the most strategic multiplayer game ever invented and a test of real skill”
d. “Learn more” clickable link

Live Support button. Modes: enabled
a. “24/7 Live chat support”
b. “Click here”
c. An image of a tech support person smiling button.

### Not Logged in Mode Action Flow:

Pressing the Logout button will display the following user message:
a. Title of message: “Logout message”
b. “Are you sure you want to quit FunDonation?
c. Please note that all the open windows will be closed and your active games will be forfeited.”
d. With the “Yes” and “No” buttons (Pressing on the “Yes” button will close the application and all the open Windows, forfeiting all the active games; Pressing on the “No” button will close the user message and get back to The main lobby screen.)

Pressing the “Help” button will do nothing.

Pressing on the “Sound on/off” button will switch the sound on and off.

Pressing the “My History”, “Deposit” or “Donate” button will display the following login/registration user message that is very similar to the general user message:
a. Title line should contain the “FunDonation.org” Logo and the string “Login message” as a header.
b. The message line should be: “Please log in before taking that action.”
c. Instead of a second text line, there should be the Registration/Login MovieClip
d. The user message itself (Besides the Registration/Login MovieClip) should have only one button called “I will log in later”. Its modes are enabled and mouse over

Pressing on the “I will log in later” button will close the Login user message and get the user back to the main lobby.

Pressing on the “X” button will close the Login user message and get the user back to the main lobby.

Pressing on the “New user click here” button will close the login user message and switch the screen with the registration screen.

Pressing on the “Login” button will start the login process according to what the user wrote in the “Account name” and “Password” text fields.

Login was successful
a. The user message disappears.
b. Main Lobby switches to “Logged In” mode (login/registration movieclip disappears from the main lobby, Welcome [dynamic text field for username] is shown instead)

Login was unsuccessful
a. The user message is disappeared.
b. A “Login error” user message is displayed:
   i. Title of the message: “Login error”
   ii. “Sorry, but we did not recognize the login information you entered, Please try to login again. If you don't have an account with us yet, you can create one here.”
c. Buttons are: “Create Account” and “Retry”

Pressing on the “Retry” button will close the “Login error” user message.

Pressing on the “X” button will close the “Login error” user message.

Pressing on the “Create Account” button will close the “Login error”

User message and will switch the screen to the registration screen.

Pressing on the “Login” button will start the login process according to what the user wrote in the “Account name” and “Password” text fields.

If the Login was successful, Main Lobby switches to “Logged In” mode

If the Login was unsuccessful, A “Login error” user message is displayed:
a. Title of the message: “Login error”
b. “Sorry, but we did not recognize the login information you entered, Please try to login again. If you don't have an account with us yet, you can create one here.”
c. Buttons are: “Create Account” and “Retry”

Pressing on the “Retry” button will close the “Login error” user message.

Pressing on the “X” button will close the “Login error” user message.

Pressing on the “Create Account” button will close the “Login error”

User message and will switch the screen to the registration screen.

Pressing on the “New user click here” button will switch the screen to the

### Registration Screen.

Pressing on the “Chess” button will switch the screen to “Chess Lobby” screen in “Not logged In” mode.

### Logged in Mode Action Flow:

The “logged in” mode looks and behaves the same as the “not logged in mode” except for the following:
a. Pressing the “My History” button switches the screen to “Account History” screen
b. Pressing the “Deposit” button switches the screen to “Deposit” screen
c. Pressing the “Donate” button switches the screen to “Donation” screen. The “Donation” screen is not detailed in this document but allows the user either to donate directly to an organization/institute/etc. . . . within the system or to declare which organization/institute/etc within the system will get the revenues of the future user's winnings.
d. Registration/Login MovieClip is removed from the “main lobby” screen. “Welcome [dynamic text field for user name]”+“your accumulated donation is [dynamic text field for donation number]”+“View Current Ranking” button is displayed.
   i. “View Current Ranking” button. Modes: enabled, mouse over

The “Deposit” button displays the current “Money available” and “Money in Play” fields.

“My next games' revenues will be donated to:”+[combo box with the default value “Not decided yet”] will be updated with the 5 recent organizations that the user wanted to donate for.

Pressing on the “Chess” button will switch the screen to “Chess Lobby” screen in “Logged In” mode.

When the user is logged in, the “Welcome guest” changes to FIG. 7

And the “connecting” sign is changed to “connected”.

### Registration Screen (Shown in FIG. 8)

The registration screen is used in order to register a new user.

A registration is needed for deposits, donations, playing and viewing the history of the games of the user.

The registration process is done only once for each user.
a. “FunDonation.org” Logo
b. “New User Registration” title
c. “Already a member” button. Modes: enabled, mouse over
d. “24/7 Live chat support” button. Modes: enabled, mouse over
e. “Cancel” button. Modes: enabled, mouse over
f. “Help” button. Modes: enabled, mouse over
g. “Submit registration” button. Modes: enabled, mouse over
h. “I accept the terms and conditions” checkbox where the text “terms and conditions” is a button linked styled.
i. “Preferred Username:” string with an input text field
j. “Preferred Password:” string with an input text field
k. “Password's length must be at least 8 characters and contain both letters and digits” string next to the “Preferred Password” string
l. “First Name:” string with an input text field
m. “Last Name:” string with an input text field
n. “Email:” string with an input text field
o. “Age:” string with an input text field
p. “Gender:” string with 2 radio buttons; “Male” and “Female”
q. “Address:” string with an input text field
r. “City:” string with an input text field
s. “Country:” string with a combo box attached to it
t. “State:” string with a combo box attached to it
u. “Zip Code:” string with an input text field
v. “Phone:” string with an input text field

Upon pressing the “submit registration” button, the registration process will take place.
The “Loading, please wait . . . ” general movieclip will be shown until the client gets a response from the server.

### Registration Succeeded:

“Loading, please wait . . . ” general movieclip disappears

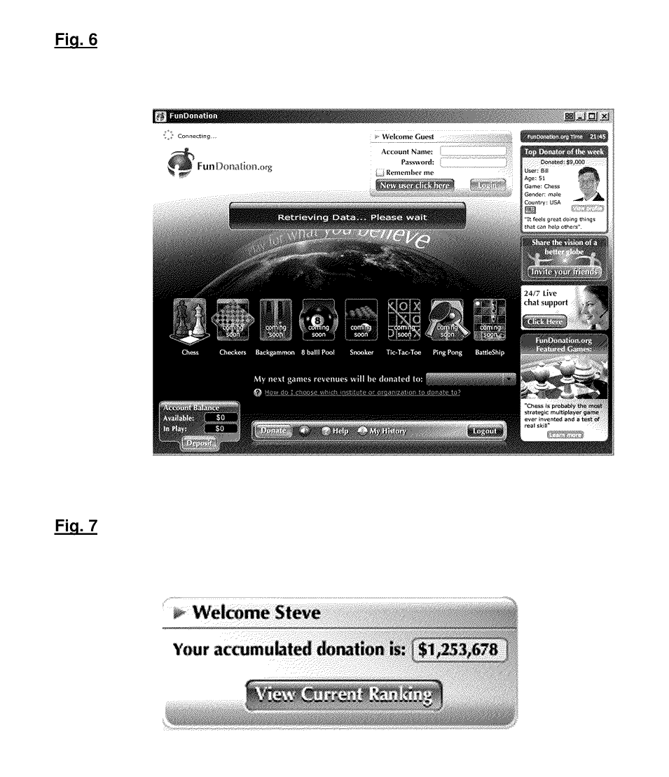

A “general user message component” (shown in FIG. 9) will be displayed with the following parameters:
a. “FunDonation.org” Logo
b. “Registration Succeeded” title for the message
c. “Dear member” string
d. “Welcome to FunDonation.org” string
e. “You have been issued a username and password” string
f. “Username:”+[dynamic text field for chosen username] string
g. “Password:”+[dynamic text field for chosen password] string
h. “Please write them down now and keep them confidential.” String “Click “OK” when you are ready to share the vision of a better globe and have fun.” String
i. “OK” button. Modes: enabled, mouse over

Pressing the “OK” button will make the “Registration succeeded” user message to disappear and the main lobby will be loaded in “Logged In” mode.

### Registration Failed:

“Loading, please wait . . . ” general movieclip disappears

A “general user message component” will be displayed with the following parameters:
a. “FunDonation.org” Logo
b. “Registration process error” title
c. Dynamic text string id will be received from the server
d. “OK” button. Modes: enabled, mouse over

Pressing the “OK” button or the “X” button on the upper right corner will close the user message, displaying the registration screen again.

The dynamic string will be one of the following:
a. “You must enter all the details before submitting the registration”+mark the blank fields with red rectangle.
b. “This form may only contain digits and letters”
c. “The Email address that you typed is invalid, please correct it and submit your registration again.”+mark the email field with red rectangle.
d. “You must be over 18 years old in order to register.”+mark the age field with red rectangle.
e. “You must be below 120 years old in order to register.”+mark the age field with a red rectangle.
f. “The preferred username that you typed has already been assigned to another member, Please choose a new username and submit your registration again.”+mark the username field with red rectangle.
g. “The preferred username that you typed is too short. Its minimal length should be 8. Please choose a new username and submit your registration again.”+mark the username field with red rectangle.
h. “The preferred password that you typed is not valid; please choose a new password that contains both digits and characters. The new password's length should be at least 8 digits and characters.”+mark the password field with red rectangle.
i. “Due to maintenance work, the registration service is disabled. Please try to register in a few minutes.”

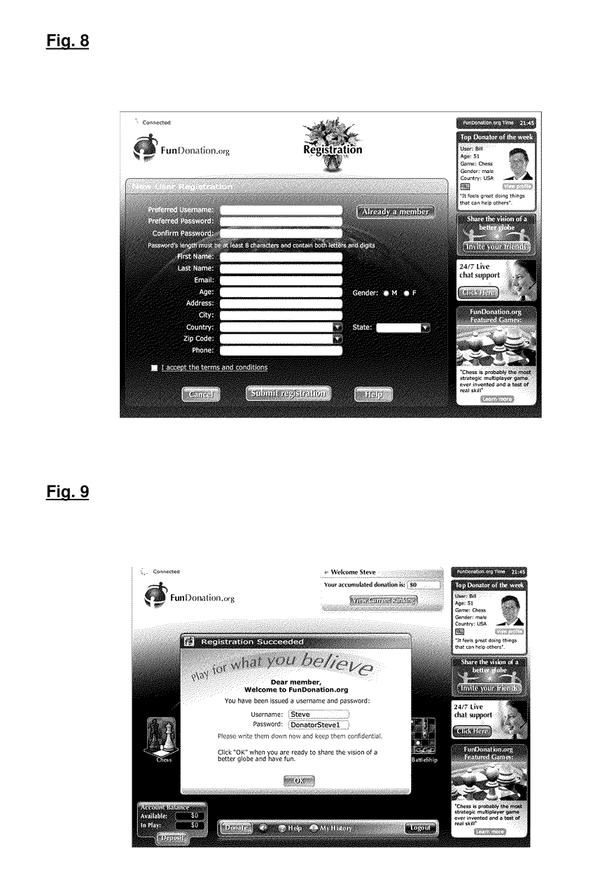

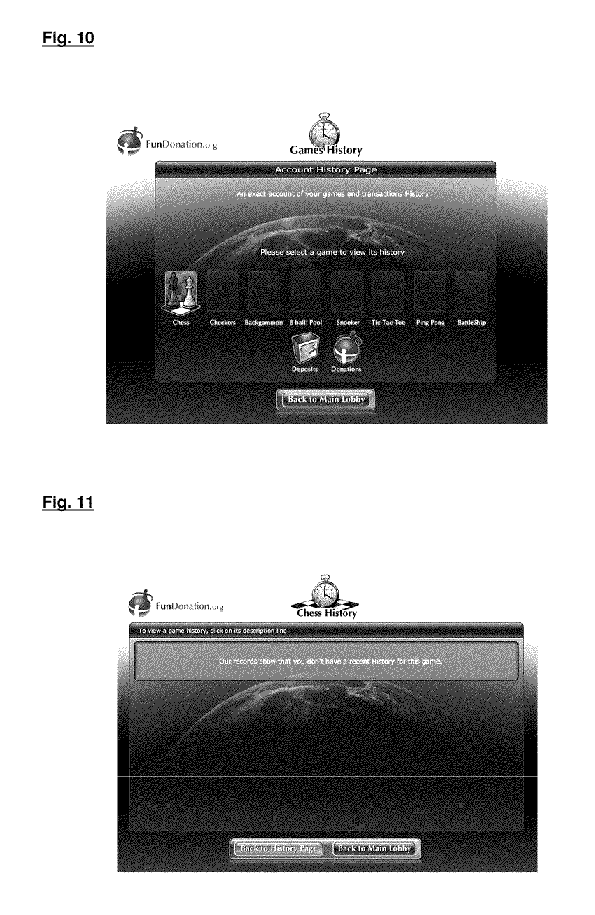

### Account History Screen (Shown in FIG. 10)

The account history screen is used to display the user all the history of his actions in the system.

The user can view the history of all his previously played games.

The user can also keep track of his deposit history and the donations he made.

In order to help the user find the history he is looking for, the account history screen is divided into sections in which a specific kind of history can be easily found.
a. “FunDonation.org” Logo
b. “Account History Page” title
c. “An exact account of your games and transactions History” string
d. “Please select a game to view your history” string
e. “Chess” button. Modes: enabled, mouse over
f. “Checkers” button. Modes: disabled
g. “Backgammon” button. Modes: disabled
h. “8 ball Pool” button. Modes: disabled
i. “Snooker” button. Modes: disabled
j. “Tic-Tac-Toe” button. Modes: disabled
k. “Ping Pong” button. Modes: disabled
l. “Battleship” button. Modes: disabled
m. “Deposits” button. Modes: enabled, mouse over
n. “Donations” button. Modes: enabled, mouse over
o. “Back to Main Lobby” button. Modes: enabled, mouse over

Pressing on the “Back to Main Lobby” button will switch the screen to the Main Lobby screen in logged in mode.

Pressing on the “Deposits” button will load the Deposit history screen (Not details in this document) which will display the history of deposit attempts for the current user.

Pressing on the “Donations” button will load the Donations history screen (Not details in this document) which will display the history of donation attempts for the current user.

Pressing on the “Chess” button will switch the screen to the “Chess History Lobby” screen.

### Chess History Lobby Screen

This screen displays the chess games that the user played in the past along with general information about them, giving him the ability to watch each game in details.

The user can be in 2 states in this screen: Either he played chess in the past or not.

### User has Never Played Chess Before (Shown in FIG. 11):

“Chess” icon

“Chess” title

“Our records show that you don't have a recent History for this game.” String

“Back to Account History Page” button. Modes: enabled, mouse over

“Back to Main Lobby” button. Modes: enabled, mouse over

Pressing on the “Back to Account History Page” will switch the screen to “Account History” screen.

Pressing on the “Back to Main Lobby” button will switch the screen to the Main Lobby screen in logged in mode.

### User Played Chess Before (Shown in FIG. 12):

“Chess” Icon

“Chess” title

“To view a game's history, click on its description line” string

“Previous games” button. Modes: enabled, mouse over

“Next games” button. Modes: enabled, mouse over

“No., Date, Bet, Time Limit, Game Id, Opponent, Result, Donated to” headers for the list of the ‘game data components’.

A fixed number of ‘game data components’ in each screen

Each ‘game data component’ is a button. Modes: enabled

Game Data Component:

Build up from 8 parts:
a. Dynamic text field for displaying the number of the current row. Value can be 1-999.
b. Dynamic text field for displaying the date of the game as mm/dd/yy (month/day/year) and a dynamic text field for displaying the time of the game hh:mm:ss (hour:minutes:seconds)
c. “$”+dynamic text field for the amount of the bet
d. 9 lines of dynamic text fields, each line displaying the time limit of the current line's game (9 is the max length of series allowed). Each text field contains: hh:mm:ss (hour:minutes:seconds) OR “Unlimited, turn time:”+hh:mm:ss (hour:minutes:seconds)
e. 9 lines of dynamic text fields, each line displaying the Game Id of the current line's game (9 is the max length of series allowed). Each text field contains a number.
f. A dynamic text field for the opponent's name, a flag icon for the Opponent's country, dynamic text field for the opponent's Country name and a “male/female component” indicating the Opponent's gender. Male/Female component is build up from the word “Male” or “Female” with a symbol of male or female accordingly.
g. lines of dynamic text fields, each line displaying the final score of The current line's game. Values may be: “You won”, “Draw” or “You lost”.
h. Dynamic text field indicating the organization that I donated to (if Won) or wanted to donate to (If lost).

“Back to Account History Page” button. Modes: enabled, mouse over

“Back to Main Lobby” button. Modes: enabled, mouse over

Pressing on one of the ‘game data components’ will switch the screen to “Chess History Game” screen displaying that specific game.

Pressing on the “Back to Account History Page” will switch the screen to “Account History” screen.

Pressing on the “Back to Main Lobby” button will switch the screen to the Main Lobby screen in logged in mode.

### Chess History Game Screen (Shown in FIG. 13)

This is the actual screen of the Chess game itself in History mode.

This screen can be accessed by “logged in” users only.
a. “FunDonation.org” Logo
b. “Chess” Icon
c. “Chess” title
d. Chess Board (Including the letters A-H and numbers 1-8)
   i. Each cell in the board should have a “marked” so when the user clicked a piece all the possible cells would be marked to help him/her choose the next move.
e. White pieces that are not on the board (eaten) should be held aside the board.
f. Black pieces that are not on the board (eaten) should be held aside the board.
g. “Flip board view” checkbox
h. 32 chess pieces (16 white and 16 black) buttons. Modes: enabled, disabled (looks the same as enabled)
i. 32 chess pieces semi 3D (16 white and 16 black) buttons. Modes: enabled, disabled (looks the same as enabled)
j. Game data display and Digital Chess Clock
   i. “(Game ID:” string+dynamic text field+“Stake:” string+dynamic text field+“Game:” string+dynamic text field+“)” string as the title
   ii. Each side of the clock will represent a player's time limit. Each side will have a pawn image (either white or black) to represent the player's color.
   iii. Each side of the clock will include:
      1. Player's country flag
      2. Player's name
      3. Player's rank
      4. “Won:” sting+dynamic text field
      5. “Time Limit:” string+dynamic text field (Shown only in case that the game is not unlimited by time.
   iv. The clock will indicate which player the clock is working for. At the end of each round the clock will start the countdown for the other player.
   v. “Turn Time Limit:” string+dynamic text indicating how much time is left for the current round is shown in the middle of the clock. (shown only if the time limit is unlimited)
k. A general floating message with dynamic text field which is half transparent and low and located at the bottom of the screen just upper of the chess clock. Used for in play messages
l. A general floating message with dynamic text field which is half transparent and high and located at the center of the screen. Used for general messages before and after the game
m. Game Log section
   i. Displays the list of moves made by the players, shown by order.
n. Navigation Tool Bar that contains:
   i. “play” button. Modes: enabled, disabled, mouse over, pressed
   ii. “stop” button. Modes: enabled, mouse over, pressed
   iii. “pause” button. Modes: enabled, pressed, mouse over (Its location should be the same as the “play” button but on a different layer)
   iv. “play 1 move forward” button. Modes: enabled, disabled, mouse over, pressed
   v. “play 1 move backward” button. Modes: enabled, disabled, mouse over, pressed
   vi. “play fast forward” button. Modes: enabled, disabled, mouse over, pressed
o. “Next game in the series” button. Modes: enabled, disabled, mouse over, pressed
p. “Previous game in the series” button. Modes: enabled, disabled, mouse over, pressed

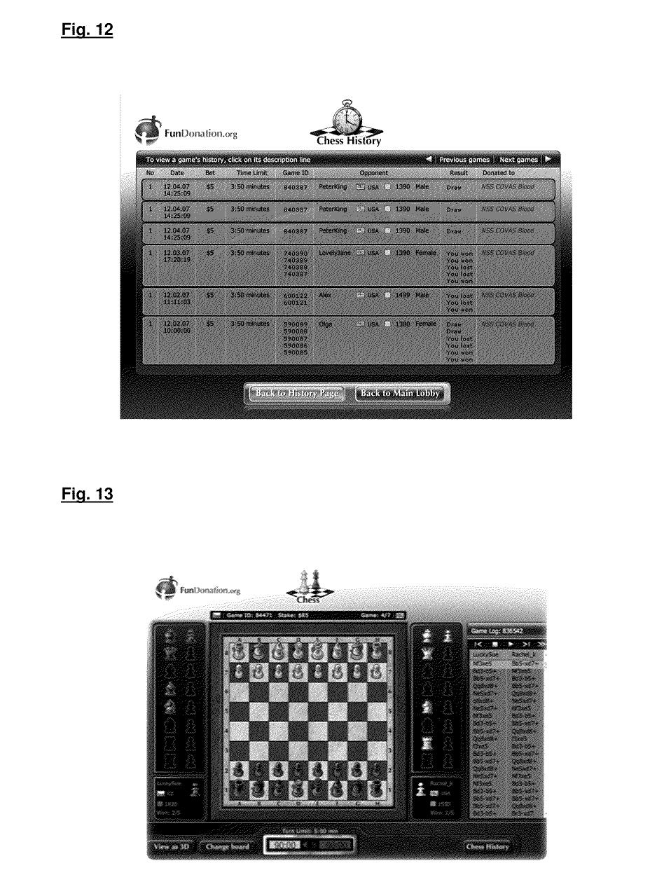

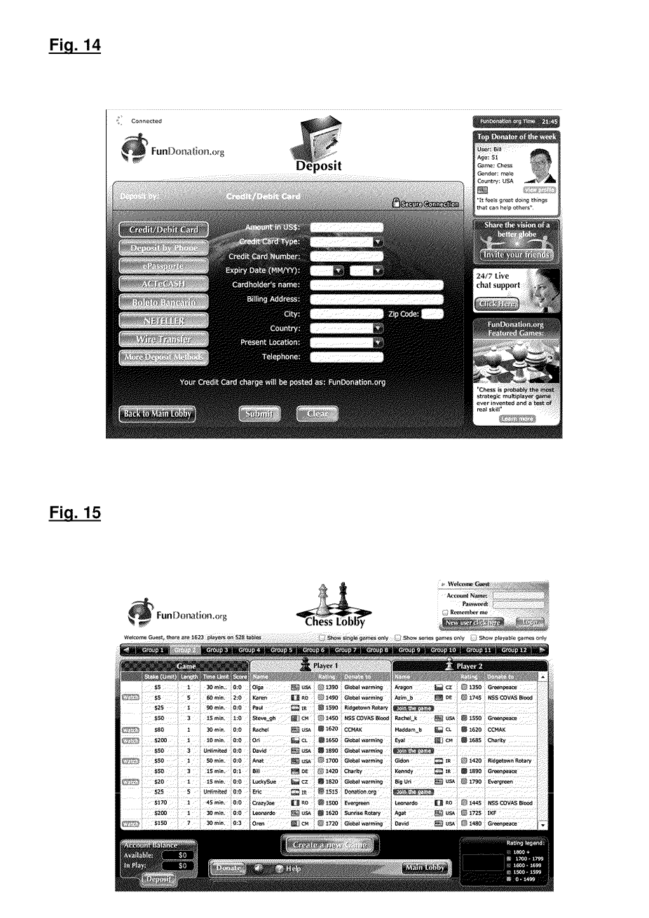

### Deposit Screen (Shown in FIG. 14)

The deposit screen is used in order to deposit funds to “FunDonation.org”.
a. “FunDonation.org” Logo
b. “Deposit” title
c. “Secure connection” icon
d. “Deposit” icon. The same button from the Main Lobby but not clickable.
e. “Deposit by” title for the various deposit options
   i. “Credit/Debit Cards” button. Modes: enabled, mouse over
   ii. “NETELLER” button. Modes: enabled, mouse over
   iii. “Deposit by phone” button. Modes: enabled, mouse over
f. “Credit/Debit Cards” title for the current selected payment method
   i. “Amount in US$:” string+input text field
   ii. “Credit Card Type:” string+combo box
   iii. “Credit Card Number:” string+input text field
   iv. “Expire Date(mm/yy):” string+combo box for months+combo box for years
   v. “Cardholder's Name:” string+input text field
   vi. “Billing Address:” string+input text field
   vii. “City:” string+input text field
   viii. “Zip Code:” string+input text field
   ix. “Country:” string+combo box for countries list
   x. “Present Location” string+combo for countries list
   xi. “Telephone:” string+input text field
   xii. “Submit” button. Modes: enabled, mouse over
   xiii. “Clear” button, Modes: enabled, mouse over
   xiv. “Back to Main Lobby” button. Modes: enabled, mouse over

Pressing the “Back to Main Lobby” button will switch the screen to the “Main Lobby” screen in logged in mode.

### Chess Lobby Screen

The Chess Lobby Screen helps the user to navigate through the various chess games available.

The user can view a game being played by others (No need to be logged in yet).

The user can join an open game and start playing (Need to be logged in) or open a new game for another player to join (Need to be logged in).

The lobby screen also informs the logged in user regarding his ranking status.

The not logged in user can log in and register while browsing the Chess Lobby as well.

As mentioned before, the chess lobby screen is used for both logged in and not logged in users.

The chess lobby looks pretty much the same in both cases except for a few minor changes.

The main different is the behavior of each button pressed.

### “Not Logged in State” (Shown in FIG. 15):

“FunDonation.org” logo

“Chess” icon

“Chess Lobby” title

Dynamic text field+“players on”+dynamic text field+“tables”

“Show single games only” check box

“Show series games only” check box

“Show playable games only” check box

“Create a new Game” animated button.

Modes: enabled, mouse over, pressed

“Deposit” button. Same one from the main lobby

“Donate” button. Same one from the main lobby.

“Sound on/off” button. Same one from the main lobby

“Help” button. Same one from the main lobby.

“Main Lobby” button. Modes: enabled, mouse over

Registration/login movieclip to allow the user to login or register.

“Game Info” section. Used to display information about the players in a specific game.
a. “Game” title
b. Border for that section
c. 2 Player's data tables, one for each player
   i. Player1/Player2 title for each table
   ii. “Name, Rating, Donate to” tables' headers
   iii. Each row in the table includes:
      1. Player's rating icon+dynamic text field for the Player's name
      2. Dynamic text field for the player's rating
      3. Player's gender icon (optional)
      4. Dynamic text field for user's country (short name)+user's country flag icon
      5. Which organization will be donated the current player's revenues if he/she wins.

Rating legend section is a static section that displays the various rating values and their colors.
a. “Rating legend” title
b. Border for that section
c. Red colored icon+“1800+” string
d. Peach colored icon+“1700-1799” string
e. Purple colored icon+“1600-1699” string
f. Blue colored icon+“1500-1599” string
g. Green colored icon+“0-1499” string

Registration/login Movieclip, same as in the main lobby

Chess Lobby Data Grid

### Chess Lobby Data Grid

The chess lobby data grid is the component that displays the various games that are either being played or open for a new player to join.

The data will be displayed in a table.

The table will have a dynamic number of selectable headers. (Example: “Classic Chess”, “Tournaments Chess”, etc. . . . )

The table will also have a dynamic number of selectable sub headers (Example: “Group 1”, “Group 2”, etc. . . . ).

The component displays 5 sub headers along with a “next” button (Modes: enabled, disabled, mouse over, pressed) and “previous” button (Modes: enabled, disabled, mouse over, pressed) to help the user navigate through all the sub headers.

Pressing on the one of the headers will show that it is chosen and its sub headers will be shown. (This feature is not shown in the attached screenshot)

Pressing on one of the sub headers will show that it is chosen and the data part of the table will be shown with correct data. Each row should be selectable.

Data part of the table:
a. “(This title is empty)”, “Stake(Limit)”, “Length”, “Time Limit”, “Score” titles
b. The maximum allowed number of rows in a screen (before scrolling down) is 25.
c. The maximum allowed number of rows in a current table (After scrolling down) is 50.
d. Each line is build from: (The order is according to the titles)
   i. Empty, “Watch” button. Modes: enabled, mouse over OR
   ii. “Remove” button. Modes: enabled, mouse over
      1. Dynamic text field for a “$”+a number
      2. Dynamic text field for a number representing the number of matches in the current game. (1 for normal and >1 for series)
      3. Dynamic text for the word “Unlimited” or the total minutes limit data for each match. (If unlimited is shown, it is being animated replaced with the time limit per turn)
      4. The current scores of the players in the current game
e. If a game has not started and player1 is waiting for another player to join the game, “Join the game” button will appear in the 2nd player table under the “Name” column.

Pressing on the “next” or “previous” button should show the new sub headers accordingly.

Pressing on the one of headers will show its sub headers.

Pressing on one of the sub headers will fill the table with the appropriate data.

Pressing on one of the rows in the table will highlight it and display its data also in the “Game Info” section

Pressing the “Join” button will act the same as pressing the “Deposit” button.

Pressing the “Watch” button will open the “Chess Game” screen in a viewer mode, not logged in mode. It will be opened in a new window.

If the “Show single games only” check box is marked, the “Show series games only” check box is unmarked and vice versa.

“Show playable games only” check box can be marked with either one Of them.

Pressing on the “Deposit” button will show a user message and act the Same way as that button in the Main Lobby in “not logged in” mode.

The only difference is that references to “Main Lobby” should be Changed to “Chess Lobby”.

Pressing on the “Donate” button will show a user message and act the Same way as that button in the Main Lobby in “not logged in” mode.

The only difference is that references to “Main Lobby” should be changed to “Chess Lobby”.

Pressing on the animated “Create a new Game” button will act the same As pressing on the “Deposit” button.

Pressing on the Sound on/off button will act the same way as in Main Lobby.

Pressing on the “Help” button does nothing at this stage.

Pressing on the “Main Lobby” button will switch the screen to Main Lobby screen in “Not logged in” mode.

Pressing on the “News and Events” button does nothing at this stage.

Registration/login Movieclip behaves the same as in Main Lobby except That any reference to Main Lobby should be switched with “Chess Lobby”.

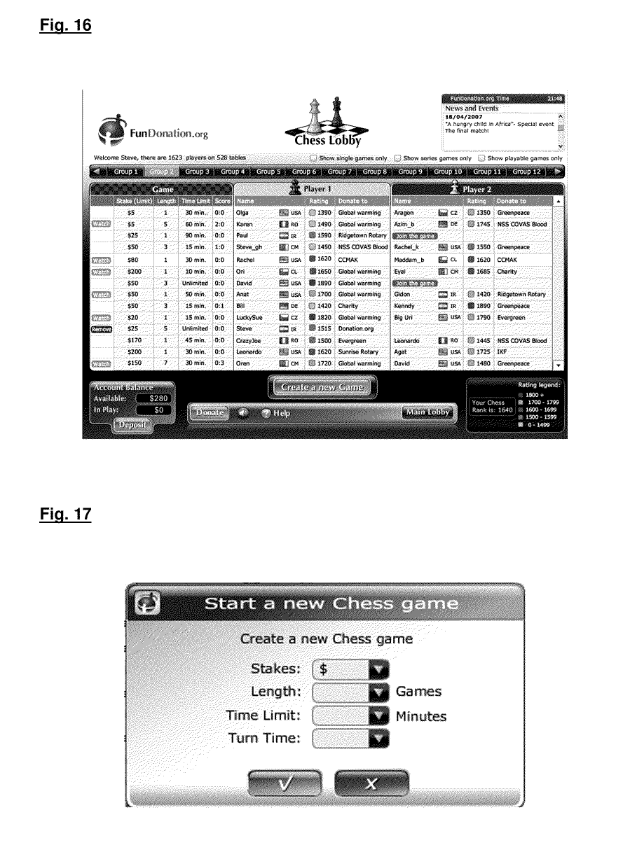

### “Logged in State” (Shown in FIG. 16):

The screen looks and acts the same as in “Not Logged in state” except that the “Registration/login movieclip” is disappeared and instead the screen displays the “News and Events” section movieclip.

“News and Events” section. Used to display the user general news and -to promote some events.
a. “News and Events”+hh:mm (hours:minutes) title
b. Multi line dynamic text for the information
c. Border for that section

The “Welcome Guest, there are . . . ” String is changed and the word “Guest” is replaced with the user's name.

“Your Chess rank is”+[rank dynamic text] is displayed with the current user's chess rank.

Pressing the “Watch” button will open the “Chess Game” screen in a viewer, Logged in mode. It will be opened in a new window.

Pressing the “Deposit” button will switch the screen to the “Deposit” screen

Pressing on the “Donate” button will switch the screen to the “Donation” screen.

The “Donation” screen is not detailed in this document but allows the user either to donate directly to an organization/institute/etc. . . . within the system or to declare which organization/institute/etc within the system will get the revenues of the future user's winnings.

Pressing on the “Main Lobby” button will switch the screen to Main Lobby screen in “Logged in” mode.

Pressing on the “Create a new Game” button will display the following user message (shown in FIG. 17):
a. “FunDonation.org” Logo
b. “Start a new Chess game” title
c. “Create a new game” string
d. “Stakes:” string+[values combo box]+“$” string
   i. There is an option to vary the stakes between the opponents in order to motivate people to compete against stronger opponents.
e. “Length:” string+[values combo box]+“Games” string
f. “Time Limit:” string+[value combo box]+“Minutes” string
g. “Turn Time:” string+[value combo box]—This line is optional and will be displayed only if the user chose “Unlimited” in the Time Limit
h. Approve button (Doesn't have to include the word ‘approve’ within). Modes: enabled, mouse over
i. Cancel button (Doesn't have to include the word ‘cancel’ within). Modes: enabled, mouse over

Pressing on the ‘cancel’ button will make the message to disappear and the user will see the Chess Lobby screen.

Pressing on the ‘approve’ button will make the message to disappear and a new row of the game will be added to the Chess Lobby.

That row will have the “Remove” button in the 1st field and only the user who created the game can see that button.

Pressing on the “remove” button in case it exists (The user opened that game) will send a message to the server and in the next refresh will delete that game's row.

Pressing on the “Join the game” button in case that the user does not have enough available money to play that game will display the following general user message:
a. “Game message” title
b. “You don't have enough funds in your “Money Available” balance to join this game, please deposit using the “Deposit” button or choose a lower stake game.”
c. “OK” button

Pressing on the “X” or the “OK” button will close the user message and will not send a “join” message to the server.

Pressing on the “Join the game” button in case that the user has enough available money to play that game will display the following general user message:
a. “Waiting for the other player to approve your joining request” title
b. “Please wait a few seconds while” string+[dynamic text field]+“approves your request to play against” string+[“him”/“her”] string+string
c. “OK” button

Pressing on the “X” or the “OK” button will make the message disappear

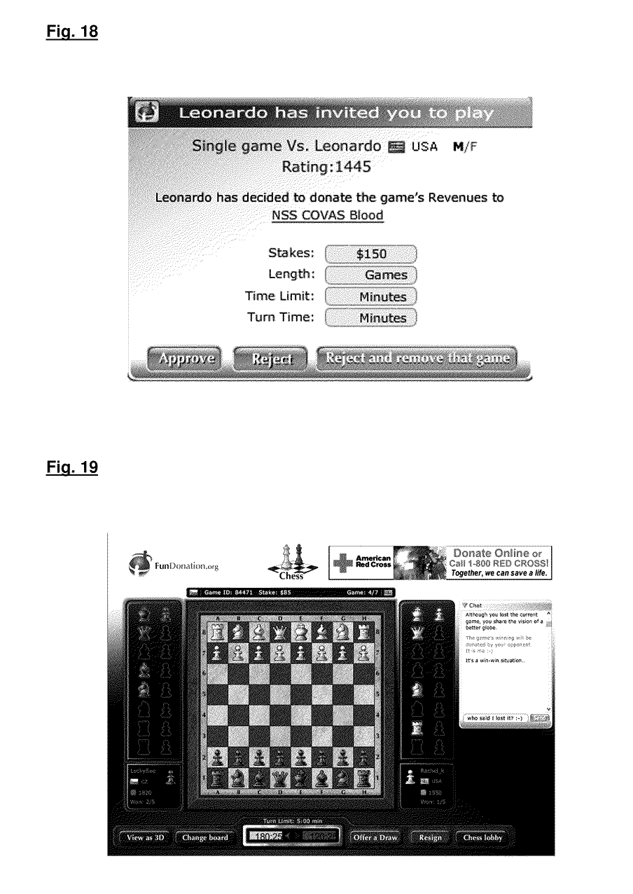

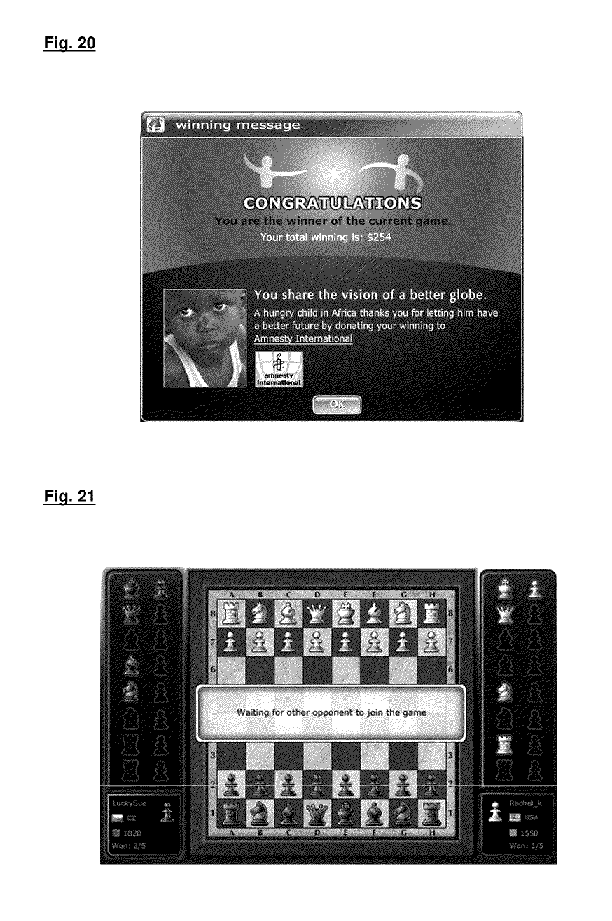

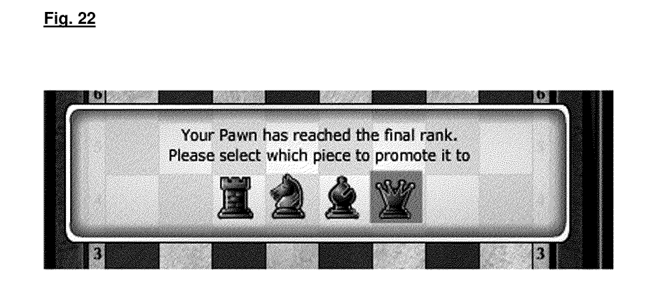

After pressing the “join” button, the initiator of the game will get the Following invitation message (shown in FIG. 18):
a. “FunDonation.org” Logo
b. [dynamic text field]+“has invited you to play a Chess game” title
c. “Single game Vs. [opponent's name dynamic text field] ”+“(Rating:”+[dynamic text field for rating]+“)”
d. [dynamic text field]+“has decided to donate the game's Revenues to”+link styled button with a text field within it +“.”
e. Opponent's country flag icon
f. Opponent's country name text field
g. Opponent's gender icon
h. “Stakes:”+[dynamic text field]+
   i. There is an option to vary the stakes between the opponents in order to motivate people to compete against stronger opponents.
i. “Length:”+[dynamic text field]+“Games
j. “Time Limit:” string+[dynamic text field]+“Minutes” string
k. “Turn Time:” string+[dynamic text field]—This line is optional and will be displayed only if the user chose “Unlimited” in the Time Limit
l. “Approve button”. Modes: enabled, mouse over
m. “Reject” button. Modes: enabled, mouse over
n. “Reject and remove that game button”. Modes: enabled, mouse over

Pressing the “Approve” button will send an approve message to the Server, close the user message and open the “Chess Game” screen in an Active mode for both players.

It will be opened in a new window.

It will also send reject messages to all the clients in queue that asked to Compete against the game creator not including the current one (through The server).

Pressing on the “Reject” button will close the user message and send a “reject” message to the other user who asked to play against me.

Pressing on the “Reject and remove that game” button will send reject Messages for all the clients in queue including the current one (through the Server). The current game will be removed from the lobby by the server.

When a client gets a reject message it displays the following general user Message:
a. “Game invitation has been declined” title
b. [dynamic text field]+“has declined your request to play against” string+[“him”/“her”] string+“.” string
c. “OK” button

Pressing the “X” or “OK” button will close the user message.

### Chess Game Screen

This is the actual screen of the Chess game itself.

This screen can either be accessed by “logged in” users or “Not logged in” users in order to view the game of another player.

In order to participate in a game the user must be “logged in”.

This window will be opened in a separate window than the Chess/Main Lobby window.

### “Logged in State” as an Active Player:

“FunDonation.org” Logo

“Chess” Icon

“Chess” title

Chess Board (Including the letters A-H and numbers 1-8)
a. Each cell in the board should have a “marked” so when the user clicked a piece all the possible cells would be marked to help him/her choose the next move.

White pieces that are not on the board (eaten) should be held aside the board, also leave space for promoted pawn.

Black pieces that are not on the board (eaten) should be held aside the board, also leave space for promoted pawn.

“Flip board view” checkbox

“Change board” button for different skins of the board

“View as 3D” checkbox

“Chess lobby” button

32 chess pieces (16 white and 16 black) buttons. Modes: enabled, disabled (looks the same as enabled)

32 chess pieces semi 3D (16 white and 16 black) buttons. Modes: enabled, disabled (looks the same as enabled)

“Chat” box
a. “Chat” title
b. Multi line Dynamic text for shown messages
c. Input text field for user's sentences
d. “Send” button. Modes: enabled, mouse over, pressed, disabled
e. Scroller to the Multi Line section

Game data display and Digital Chess Clock
a. “(Game ID:” string+dynamic text field+“Stake:” string+dynamic text field+“Game:” string+dynamic text field+“)” string as the title
b. Each side of the clock will represent a player's time limit. Each side will have a pawn image (either white or black) to represent the player's color.
c. Each side of the clock will include:
   i. Player's country flag
   ii. Player's name
   iii. Player's rank
   iv. “Won:” sting+dynamic text field
   v. “Time Limit:” string+dynamic text field (Shown only in case that the game is not unlimited by time.
d. The clock will indicate which player the clock is working for. At the end of each round the clock will start the countdown for the other player.
e. “Turn Time Limit:” string+dynamic text indicating how much time is left for the current round is shown in the middle of the clock. (shown only if the time limit is unlimited)

“Offer a Draw” button. Modes: enabled, disabled, clicked, mouse over

“Resign” button. Modes: enabled, disabled, clicked, mouse over

A general floating message with dynamic text field which is half transparent and low and located at the bottom of the screen just upper of the chess clock. Used for in play messages

A general floating message with dynamic text field which is half transparent and high and located at the center of the screen. Used for general messages before and after the game

A winning message is shown to the winner (shown in FIG. 20). The winner may have declared which organization will get the winnings.
a. “CONGRATULATIONS, you are the winner of the current game. Your total winning is”+dynamic text field. You share the vision of a better globe. “A hungry child in Africa thanks you for letting him have a better future by donating your winning to”+“Amnesty International” linked styled button (modes: enabled)+an image of an African child smiling. “OK” button at the bottom of the message. Modes: enabled, mouse over
b. “CONGRATULATIONS, you are the winner of the current game. Your total winning is”+dynamic text field.
c. “You share the vision of a better globe”+dynamic text field for general information of the organization that will get the donation+organization's name link styled button (Modes: enabled)
d. “OK” button at the bottom of the message. Modes: enabled, mouse over

A losing message is shown to the loser. (shown in FIG. 19)
a. “Although you lost the current game, you share the vision of a better globe and your part of the donation will be credited.”+Dynamic text field for general information of the organization that will get the donation+organization's name link styled button (Modes: enabled)+“OK” button at the bottom of the Message.
b. Modes: enabled, mouse over

Pawn promote message box should be displayed in case the pawn has arrived the last cell and the player want to update the pawn to another piece. (shown in FIG. 22)

### “Not Logged in State”/Logged in State as a Viewer:

Looks the same as a logged in state active player but:
a. “Resign” button is not shown
b. “Offer a Draw” button is not shown
c. “Exit Game” button is shown. Modes: enabled, mouse over

A Logged in player can participate in the chat

A not logged in player cannot participate in the chat but can view what others are writing.

A viewer will also see the result of the game+the target of the donation (link styled). Example of a message:
a. “dynamic text field+” is the winner of the current game. The total winning is “+dynamic text field. dynamic text field+shares the vision of a better globe.”
   A hungry child in Africa thanks”+dynamic text field (him/her)+“for letting him have a better future by donating to”+“Amnesty International” linked styled button (modes: enabled)+an image of an African child smiling.
“OK” button at the bottom of the message. Modes: enabled, mouse over
b. dynamic text field+“is the winner of the current game.”+dynamic text field (him/her)+“total winning is”+dynamic text field. dynamic text field+shares the vision of a better globe.
“OK” button at the bottom of the message. Modes: enabled, mouse over

Some embodiments of the present invention may include a method of facilitating charitable donations that may be comprised of associating possible outcomes of a game with charities, accepting wagers against these outcomes and, in response to these outcomes actually occurring, electronically transferring funds to accounts associated with said charities. This method may include receiving input from wagerers.

Some further embodiments of the present invention may include a system for facilitating charitable donation comprising a server which may be adapted to: associate possible outcomes of a game with charities, accept, through communication modules, online wagers against these outcomes, and in response to these outcomes actually occurring, electronically credit substantially all the wagered sums to accounts associated with said charities. Said server may be further adapted to receive inputs from wagerers designating said charities and wagers

Some further embodiments of the present invention may include a method of facilitating charitable donations that may be comprised of facilitating, through a data network, competitive online games between participants, associating funds with possible outcomes of those games, and, in response to possible outcomes of the games occurring, electronically crediting accounts, associated with certain charities, funds associated with those occurrences. This method may include soliciting said funds, via a communication module, from one or more of said participants. This method may also include determining said charities according to input received from said participants, via a communication module.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A method of facilitating a charitable donation comprising:
associating on a server a first possible outcome of a game with a first charity;
accepting online wagers against the first possible outcome; and
in response to the first possible outcome actually occurring, electronically crediting a portion of the wagered sums to an account associated with the first charity.

2. The method according to claim 1, further comprising associating a second charity with a second possible outcome of the game and accepting online wagers against the second possible outcome.

3. The method according to claim 1, wherein the step of associating a first outcome with a first charity includes receiving an input from a first wagerer designating the first charity and wagering in favor of the first outcome.

4. The method according to claim 3, wherein the first wagerer keeps their wagered sum in response to the first possible outcome actually occurring.

5. The method according to claim 2, wherein the step of associating the second outcome with a second charity includes receiving an input from a second wagerer designating the second charity and wagering in favor of the second outcome.

6. The method according to claim 5, wherein the second wagerer loses their wagered sum in response to the first possible outcome actually occurring, such the second wagerer's wagered sum is transferred to the first charity.

7. The method according to claim 1, wherein in response to the first possible outcome actually occurring, a portion of the wagered sums are electronically credited to an account associated with a first wagerer.

8. The method according to claim 1, wherein funds are transferred internationally.

9. A system for facilitating a charitable donation comprising:
a server adapted to associate a first possible outcome of a game with a first charity;
said server is further adapted to accept, through communication modules, online wagers against the first possible outcome; and
in response to the first possible outcome actually occurring, to electronically credit substantially all the wagered sums to an account associated with the first charity.

10. The system according to claim 9, wherein said server is further adapted to associate a second charity with a second possible outcome of the game and to accept online wagers against the second possible outcome.

11. The system according to claim 9, wherein said server is further adapted to receive an input from a first wagerer designating the first charity and wagering in favor of the first outcome.

12. The system according to claim 11, wherein said server is further adapted to allow the first wagerer to keep their wagered sum in response to the first possible outcome actually occurring.

13. The system according to claim 9, wherein said server is further adapted to receive an input from a second wagerer designating the second charity and wagering in favor of the second outcome.

14. A method of facilitating a charitable donation comprising:
facilitating through a data network a competitive online game between participants;
associating funds with said game;
associating a first charity with a first possible outcome of said game; and
in response to the first possible outcome of the game actually occurring, electronically crediting a portion of the funds associated with that game to an account associated with the first charity

15. A method according to claim 14, wherein the associated funds are solicited, via a communication module, from one or more participants in the competitive game

16. A method according to claim 14, wherein the first charity is determined by receiving an input, via a communication module, from one or more of the participants in the competitive game

17. A method according to claim 14, wherein in response to a second possible outcome of the game occurring, electronically crediting a portion of the funds associated with that game to an account associated with a second charity.
